(19) United States
(12) Patent Application Publication
(10) Pub. No.: US 2014/0155550 A1
(43) Pub. Date: Jun. 5, 2014

(54) THERMOPLASTIC ELASTOMER COMPOSITION

(71) Applicant: SUMITOMO RUBBER INDUSTRIES, LTD., Kobe-shi (JP)

(72) Inventor: Katsushi YAMAMOTO, Kobe-shi (JP)

(73) Assignee: SUMITOMO RUBBER INDUSTRIES, LTD., Kobe-shi (JP)

(21) Appl. No.: 14/087,942

(22) Filed: Nov. 22, 2013

(30) Foreign Application Priority Data
Dec. 5, 2012 (JP) 2012-266372

(51) Int. Cl. C08L 9/00

(52) U.S. Cl. CPC C08L 9/00
USPC 525/152

(57) ABSTRACT

A thermoplastic elastomer composition is free from halogens such as bromine, and is comparable or superior in tensile characteristic to a conventional thermoplastic elastomer composition containing a brominated alkylphenol formaldehyde resin as a crosslinking agent. The composition contains an EPDM containing 5-ethylidene-2-norbornene as a diene component, 75 to 300 mass % of an alkylphenol formaldehyde resin having methylol groups at opposite molecular terminals thereof as a crosslinking agent based on the diene amount of the EPDM, 0.7 to 3 mass % of a strong Bronsted acid as a catalyst based on the amount of the alkylphenol formaldehyde resin, and a thermoplastic resin.

### TECHNICAL FIELD

The present invention relates to a thermoplastic elastomer composition.

### BACKGROUND ART

Various types of sheet conveying rollers are incorporated in a sheet conveying mechanism provided, for example, in an image forming apparatus such as a laser printer, an electrostatic copying machine, a plain paper facsimile machine, a printer-copier-facsimile multifunction machine or an inkjet printer, or machinery such as an automatic teller machine (ATM).

Examples of the sheet conveying rollers include a sheet feed roller, a transport roller, a platen roller and a sheet output roller, which are each rotatable in contact with a sheet to frictionally convey the sheet (the term “sheet” is herein defined to include a paper sheet, a plastic film and the like, and this definition is effective in the following description).

A known sheet conveying roller is made from a thermoplastic elastomer composition of a so-called dynamically crosslinked type, i.e., produced by kneading a thermoplastic resin and a crosslinkable rubber with heating to dynamically crosslink the rubber in the thermoplastic resin.

A sheet conveying roller to be used in an electrophotographic image forming apparatus such as a laser printer is required to be resistant to ozone to be generated in the apparatus, i.e., required to have ozone resistance. Therefore, an ethylene propylene diene rubber (EPDM) which includes a reduced number of unsaturated bonds and is less susceptible to ozone degradation is advantageously used as a rubber to be blended in the thermoplastic elastomer composition of the dynamically crosslinked type.

In general, a brominated alkylphenol formaldehyde resin is used as a crosslinking agent for dynamically crosslinking the EPDM.

In recent years, however, a technique which does not employ the brominated alkylphenol formaldehyde resin has been required to reduce the environmental load of halogens.

Patent Literature 1 proposes a thermoplastic elastomer composition which employs an alkylphenol formaldehyde resin having methylol groups at opposite molecular terminals thereof instead of the brominated alkylphenol formaldehyde resin as the crosslinking agent for the EPDM and employs an alkylbenzenesulfonic acid as a catalyst for promoting the crosslinking of the EPDM with the alkylphenol formaldehyde resin.

### PRIOR ART LITERATURE

### Patent Literature

Patent Literature 1: JP2000-169644A

### SUMMARY OF INVENTION

### Problems to be Solved by the Invention

In the prior art invention disclosed in Patent Literature 1, the alkylbenzenesulfonic acid is blended as the catalyst in a proportion of not less than 0.01 part by mass and not greater than 10 parts by mass based on 100 parts by mass of a rubber component including the EPDM. Where the prior-art thermoplastic elastomer composition is used for formation of a pipe joint, this arrangement is preferred because a metal member kept in contact with the pipe joint is less susceptible to corrosion.

However, the prior-art thermoplastic elastomer composition employing the crosslinking agent and the catalyst in combination as disclosed in Patent Literature 1 tends to be poorer in tensile characteristic such as tensile strength and breaking elongation after the dynamic crosslinking of the EPDM as compared with the conventional thermoplastic elastomer composition containing the brominated alkylphenol formaldehyde resin as the crosslinking agent.

Where the prior-art thermoplastic elastomer composition is used for the sheet conveying roller, therefore, it will be impossible to ensure a proper sheet feeding performance for a longer period of time (the sheet feeding durability is liable to be reduced).

It is an object of the present invention to provide a novel halogen-free (e.g., bromine-free) thermoplastic elastomer composition which is comparable or superior in tensile characteristic to the conventional thermoplastic elastomer composition containing the brominated alkylphenol formaldehyde resin as the crosslinking agent and hence can provide a sheet conveying roller, for example, which is capable of maintaining an excellent sheet feeding performance for a longer period time from the initial stage of use.

### Solution to Problem

In order to solve the aforementioned problem, the inventor of the present invention conducted detailed studies for improvement of the prior-art thermoplastic elastomer composition disclosed in Patent Literature 1.

As a result, the inventor found that the thermoplastic elastomer composition can be improved by selectively using an EPDM containing 5-ethylidene-2-norbornene as a diene component, selectively using a strong Bronsted acid out of Bronsted acids such as an alkylbenzenesulfonic acid, and setting the proportion of the alkylphenol formaldehyde resin as the crosslinking agent and the proportion of the strong Bronsted acid within predetermined ranges.

According to the present invention, there is provided a thermoplastic elastomer composition, which comprises: an ethylene propylene diene rubber containing 5-ethylidene-2-norbornene as a diene component; not less than 75 mass % and not greater than 300 mass % of an alkylphenol formaldehyde resin having methylol groups at opposite molecular terminals thereof as a crosslinking agent based on the diene amount of the ethylene propylene diene rubber; not less than 0.7 mass % and not greater than 3 mass % of a strong Bronsted acid as a catalyst based on the amount of the alkylphenol formaldehyde resin; and a thermoplastic resin.

In the present invention, the proportion of the alkylphenol formaldehyde resin as the crosslinking agent and the proportion of the strong Bronsted acid as the catalyst are limited to the aforementioned ranges for the following reasons.

If the proportion of the alkylphenol formaldehyde resin is less than 75 mass % or greater than 300 mass % based on the diene amount of the EPDM, the thermoplastic elastomer composition has a lower tensile characteristic after dynamic crosslinking.

If the proportion of the strong Bronsted acid is less than 0.7 mass % or greater than 3 mass % based on the amount of the alkylphenol formaldehyde resin, the thermoplastic elastomer composition has a lower tensile characteristic after dynamic crosslinking.

In either case, therefore, a sheet conveying roller formed from such a thermoplastic elastomer composition has a reduced sheet feeding durability, failing to maintain an excellent sheet feeding performance for a longer period of time from the initial stage of use.

Where the proportion of the alkylphenol formaldehyde resin and/or the proportion of the strong Bronsted acid is less than the aforementioned range, the tensile characteristic of the thermoplastic elastomer composition is reduced, because the EPDM cannot be sufficiently dynamically crosslinked.

Where the proportion of the alkylphenol formaldehyde resin and/or the proportion of the strong Bronsted acid is greater than the aforementioned range, the tensile characteristic of the thermoplastic elastomer composition is reduced, because the alkylphenol formaldehyde resin present in an excess amount has a relatively low molecular weight and hence does not create a reinforcement effect and the strong Bronsted acid present in an excess amount cuts the molecular chains of the alkylphenol formaldehyde resin.

Where the proportion of the alkylphenol formaldehyde resin and the proportion of the strong Bronsted acid are within the aforementioned ranges, on the other hand, the thermoplastic elastomer composition is comparable or superior in tensile characteristic to the conventional thermoplastic elastomer composition containing the brominated alkylphenol formaldehyde resin as the crosslinking agent. In addition, the thermoplastic elastomer composition is free from halogens such as bromine. Thus, the inventive thermoplastic elastomer composition can be provided, for example, for a sheet conveying roller, which is capable of maintaining an excellent sheet feeding performance for a longer period time from the initial stage of use.

The alkylphenol formaldehyde resin per se has a relatively low molecular weight, and directly influences the tensile characteristic of the thermoplastic elastomer composition. Therefore, as the proportion of the alkylphenol formaldehyde resin is increased in the aforementioned range, the tensile characteristic of the thermoplastic elastomer composition after the dynamic crosslinking tends to be reduced.

For further improvement of the tensile characteristic, the proportion of the alkylphenol formaldehyde resin is preferably relatively small with respect to the proportion of the EPDM, and particularly preferably not greater than 9 parts by mass based on 100 parts by mass of the EPDM.

If the proportion of the alkylphenol formaldehyde resin is excessively small, however, it will be impossible to sufficiently dynamically crosslink the EPDM as described above, thereby adversely reducing the tensile characteristic. Therefore, the proportion of the alkylphenol formaldehyde resin is preferably not less than 3 parts by mass based on 100 parts by mass of the EPDM.

In consideration of easy handling and availability, p-toluenesulfonic acid monohydrate is preferably used as the strong Bronsted acid.

Preferred examples of the thermoplastic resin include polypropylenes, which are not crosslinked together with the EPDM nor inhibit the crosslinking of the EPDM. In addition, the polypropylenes are highly miscible with the EPDM, capable of imparting the thermoplastic elastomer composition with proper flexibility and elasticity, and highly ozone-resistant.

The proportion of the thermoplastic resin is preferably not less than 10 parts by mass and not greater than 400 parts by mass based on 100 parts by mass of the EPDM in order to impart the thermoplastic elastomer composition with excellent flexibility and elasticity while ensuring excellent thermal workability attributable to the thermoplastic resin.

### Effects of Invention

According to the present invention, a novel halogen-free (e.g., bromine-free) thermoplastic elastomer composition can be provided, which is comparable or superior in tensile characteristic to the conventional thermoplastic elastomer composition containing the brominated alkylphenol formaldehyde resin as the crosslinking agent and hence can provide a sheet conveying roller, for example, which is capable of maintaining an excellent sheet feeding performance for a longer period time from the initial stage of use.

### DESCRIPTION OF EMBODIMENTS

The inventive thermoplastic elastomer composition contains: an EPDM containing 5-ethylidene-2-norbornene as a diene component; not less than 75 mass % and not greater than 300 mass % of an alkylphenol formaldehyde resin having methylol groups at opposite molecular terminals thereof as a crosslinking agent based on the diene amount of the EPDM; not less than 0.7 mass % and not greater than 3 mass % of a strong Bronsted acid as a catalyst based on the amount of the alkylphenol formaldehyde resin; and a thermoplastic resin.

<EPDM>

Examples of the EPDM include various EPDMs each containing 5-ethylidene-2-norbornene as the diene component. A so-called oil-extension type EPDM extended with an extension oil or a so-called non-oil-extension type EPDM not extended with an extension oil may be used as the EPDM.

Specific examples of the oil-extension type EPDM containing 5-ethylidene-2-norbornene as the diene component include ESPRENE 603 (having a Mooney viscosity ML₁₊₄(125° C.) of 58, a diene content of 4.5 mass % and an extension oil amount of 40 PHR) and ESPRENE 601F (having a Mooney viscosity ML₁₊₄(125° C.) of 73, a diene content of 3.5 mass % and an extension oil amount of 70 PHR) available from Sumitomo Chemical Co., Ltd., which may be used either alone or in combination.

Specific examples of the non-oil-extension type EPDM containing 5-ethylidene-2-norbornene as the diene component include ESPRENE 502 (having a Mooney viscosity ML₁₊₄(125° C.) of 62 and a diene content of 4.0 mass %) and ESPRENE 553 (having a Mooney viscosity ML₁₊₄(150° C.) of 74 and a diene content of 4.5 mass %) available from Sumitomo Chemical Co., Ltd., which may be used either alone or in combination.

### <Alkylphenol Formaldehyde Resin>

Examples of the alkylphenol formaldehyde resin as the crosslinking agent include various halogen-free (bromine-free) alkylphenol formaldehyde resins each having methylol groups at opposite molecular terminals thereof and synthesized through a two-stage reaction including an addition reaction and a condensation reaction between an alkylphenol and formaldehyde.

Examples of the alkylphenol include alkylphenols each having an alkyl group having 1 to about 10 carbons, particularly an amyl group, a 2-ethylhexyl group, a tert-octyl group or the like, bonded at an ortho- or para-position of a benzene ring of the phenol.

Specific examples of the alkylphenol formaldehyde resin include TACKIROL 201 available from Taoka Chemical Co., Ltd. and RESITOP PS-2608 available from Gunei Chemical Industry Co., Ltd., which may be used either alone or in combination.

The proportion of the alkylphenol formaldehyde resin to be blended is limited to the range of not less than 75 mass % and not greater than 300 mass % based on the diene amount of the EPDM.

If the proportion of the alkylphenol formaldehyde resin falls outside the aforementioned range, the thermoplastic elastomer composition has a reduced tensile characteristic after the dynamic crosslinking. Therefore, a sheet conveying roller formed from the thermoplastic elastomer composition has a reduced sheet feeding durability, failing to maintain an excellent sheet feeding performance for a longer period of time from the initial stage of use.

Where the proportion of the alkylphenol formaldehyde resin is less than the aforementioned range, the tensile characteristic of the thermoplastic elastomer composition is reduced, because the EPDM cannot be sufficiently dynamically crosslinked.

Where the proportion of the alkylphenol formaldehyde resin is greater than the aforementioned range, the tensile characteristic of the thermoplastic elastomer composition is reduced, because the alkylphenol formaldehyde resin present in an excess amount has a relatively low molecular weight and hence does not create a reinforcement effect and the strong Bronsted acid present in an excess amount cuts the molecular chains of the alkylphenol formaldehyde resin.

Where the proportion of the alkylphenol formaldehyde resin is within the aforementioned range and the strong Bronsted acid is used in the predetermined amount as will be described later, it is possible to provide a halogen-free (bromine-free) thermoplastic elastomer composition which is comparable or superior in tensile characteristic to the conventional thermoplastic elastomer composition containing the brominated alkylphenol formaldehyde resin as the crosslinking agent and to provide a sheet conveying roller formed from the thermoplastic elastomer composition and capable of maintaining an excellent sheet feeding performance for a longer period of time from the initial stage of use.

For further improvement of the effects, the proportion of the alkylphenol formaldehyde resin is particularly preferably not greater than 190 mass % in the aforementioned range based on the diene amount of the EPDM.

Where the non-oil-extension type EPDM is used as the EPDM, for example, the diene amount of the EPDM on which the proportion of the alkylphenol formaldehyde resin is based is the amount of the diene contained in the non-oil-extension type EPDM.

Where the non-oil-extension type EPDM has a diene content of 4.5 mass %, for example, the diene amount is 4.5 parts by mass based on 100 parts by mass of the non-oil-extension type EPDM, and the proportion of the alkylphenol formaldehyde resin is not less than 75 mass % and not greater than 300 mass % of a diene amount of 4.5 parts by mass, i.e., not less than 3.375 parts by mass and not greater than 13.5 parts by mass.

In the case of the oil-extension type EPDM, the diene amount is the amount of the diene contained in a solid component (EPDM) of the oil-extension type EPDM.

Where the oil-extension type EPDM contains the EPDM and the extension oil in a mass ratio of 100:100 and has a diene content of 2.0 mass %, for example, the diene amount is 4.0 parts by mass based on 100 parts by mass of the solid component (EPDM) of the oil-extension type EPDM, and the proportion of the alkylphenol formaldehyde resin is not less than 75 mass % and not greater than 300 mass % of a diene amount of 4.0 parts by mass, i.e., not less than 2.8 parts by mass and not greater than 12 parts by mass.

The alkylphenol formaldehyde resin per se has a relatively low molecular weight, and directly influences the tensile characteristic of the thermoplastic elastomer composition. That is, the tensile characteristic of the thermoplastic elastomer composition tends to be reduced, as the proportion of the alkylphenol formaldehyde resin is increased.

For further improvement of the tensile characteristic of the thermoplastic elastomer composition, therefore, the proportion of the alkylphenol formaldehyde resin is preferably relatively small with respect to the proportion of the EPDM, and particularly preferably not greater than 9 parts by mass based on 100 parts by mass of the EPDM.

Where the proportion of the alkylphenol formaldehyde resin is excessively small, however, it will be impossible to sufficiently dynamically crosslink the EPDM, thereby inversely reducing the tensile characteristic of the thermoplastic elastomer composition. Therefore, the proportion of the alkylphenol formaldehyde resin is preferably not less than 3 parts by mass based on 100 parts by mass of the EPDM.

Where the non-oil-extension type EPDM is used as the EPDM, 100 parts by mass of the EPDM on which the proportion of the alkylphenol formaldehyde resin is based is the amount of the non-oil-extension type EPDM. Where the oil-extension type EPDM is used as the EPDM, 100 parts by mass of the EPDM on which the proportion of the alkylphenol formaldehyde resin is based is the amount of the solid component (EPDM) of the oil-extension type EPDM.

<Strong Bronsted Acid>

From various compounds classified in Bronsted-Lowry acids, a strong Bronsted acid having an ionization degree of about 1 in an aqueous solution is selected as the catalyst for promoting the crosslinking of the EPDM with the alkylphenol formaldehyde resin.

Examples of the strong Bronsted acid include p-toluenesulfonic acid monohydrate, dodecylbenzenesulfonic acid and sulfuric acid, which may be used either alone or in combination.

In consideration of easy handling and availability, p-toluenesulfonic acid monohydrate is preferred as the strong Bronsted acid.

The proportion of the strong Bronsted acid to be blended is limited to the range of not less than 0.7 mass % and not greater than 3 mass % based on the amount of the alkylphenol formaldehyde resin.

If the proportion of the strong Bronsted acid falls outside the aforementioned range, the thermoplastic elastomer composition is liable to have a reduced tensile characteristic after the dynamic crosslinking. Therefore, the sheet conveying roller formed from the thermoplastic elastomer composition is liable to have a reduced sheet feeding durability, failing to maintain an excellent sheet feeding performance for a longer period of time from the initial stage of use.

Where the proportion of the strong Bronsted acid is less than the aforementioned range, the tensile characteristic of the thermoplastic elastomer composition is reduced, because the EPDM cannot be sufficiently dynamically crosslinked.

Where the proportion of the strong Bronsted acid is greater than the aforementioned range, the tensile characteristic of the thermoplastic elastomer composition is reduced, because the strong Bronsted acid present in an excess amount cuts the molecular chains of the alkylphenol formaldehyde resin.

Where the proportion of the strong Bronsted acid is within the aforementioned range and the predetermined amount of the alkylphenol formaldehyde resin is used in combination with the strong Bronsted acid, on the other hand, it is possible to provide a halogen-free (bromine-free) thermoplastic elastomer composition which is comparable or superior in tensile characteristic to the conventional thermoplastic elastomer composition containing the brominated alkylphenol formaldehyde resin as the crosslinking agent and to provide a sheet conveying roller formed from the thermoplastic elastomer composition and capable of maintaining an excellent sheet feeding performance for a longer period of time from the initial stage of use.

<Thermoplastic Resin>

Usable examples of the thermoplastic resin include various thermoplastic resins miscible with the EPDM.

Among these thermoplastic resins, olefin resins are preferred, which are not crosslinked together with the EPDM nor inhibit the crosslinking of the EPDM. Examples of the olefin resins include polyethylenes, polypropylenes, ethylene ethyl acrylate resins, ethylene vinyl acetate resins, ethylene methacrylic acid resins and ionomer resins, which may be used either alone or in combination.

Particularly, the polypropylenes are preferred, which are highly miscible with the EPDM, capable of imparting the thermoplastic elastomer composition with proper flexibility and elasticity, and highly ozone-resistant.

Specific examples of the polypropylenes include NOVATECH series BC6C, BC8 and the like available from Japan Polypropylene Corporation, which are used either alone or in combination.

The proportion of the thermoplastic resin to be blended is preferably not less than 10 parts by mass and not greater than 400 parts by mass, particularly preferably not less than 25 parts by mass and not greater than 70 parts by mass, based on 100 parts by mass of the EPDM in order to impart the thermoplastic elastomer composition with excellent flexibility and elasticity while ensuring excellent thermal workability attributable to the thermoplastic resin.

### <Other Components>

As required, various additives may be added to the inventive thermoplastic elastomer composition. Examples of the additives include a plasticizer, a softener, a reinforcing agent, a filler, an anti-aging agent, an anti-oxidant, a UV absorbing agent, a lubricant, a pigment, an anti-static agent, a flame retarder, a neutralizing agent and an anti-bubbling agent, which may be blended either alone or in combination in a desired proportion.

<Preparation of Thermoplastic Elastomer Composition>

The strong Bronsted acid as the catalyst and an additive such as an oil are blended in predetermined proportions with the EPDM, and the resulting mixture is kneaded by rolls or the like and then pelletized.

In turn, the thermoplastic resin and the alkylphenol formaldehyde resin as the crosslinking agent are blended in predetermined proportions with the resulting pellets, and the resulting mixture is kneaded with heating by means of an extruder, a Banbury mixer, a kneader or the like. Thus, the EPDM is dynamically crosslinked in the thermoplastic resin, whereby the thermoplastic elastomer composition is prepared.

<Production of Sheet Conveying Roller>

The thermoplastic elastomer composition is formed into a tubular body by an extrusion process or the like, and a shaft is press-inserted into the tubular body. As required, the tubular body is cut to a predetermined length, and/or the outer peripheral surface of the tubular body is polished. Thus, the sheet conveying roller is produced.

The sheet conveying roller may be produced as having a porous structure by foaming the thermoplastic elastomer composition during the formation of the tubular body. For improvement of the durability, however, the sheet conveying roller preferably has a non-porous structure containing substantially no cells therein.

The application of the inventive thermoplastic elastomer composition is not limited to the material for the sheet conveying roller, but the inventive thermoplastic elastomer composition can be advantageously used as a material for various molded or formed products required to have an excellent tensile characteristic for a longer period of time from the initial stage of use. In any case, the inventive thermoplastic elastomer composition can be molded or formed into a product which is excellent in tensile characteristic and the like and free from halogens such as bromine and, hence, has a reduced environmental load.

### EXAMPLES

### Example 1

First, 20 parts by mass of a paraffin oil (DIANA PROCESS OIL PW32 available from Idemitsu Petrochemical Co., Ltd. and having a dynamic viscosity of 30 mm²/s (at 40° C.) and 0.025 parts by mass of p-toluenesulfonic acid monohydrate as the strong Bronsted acid were blended with 100 parts by mass of an EPDM (ESPRENE 553 available from Sumitomo Chemical Co., Ltd. and having a Mooney viscosity ML₁₊₄(150° C.) of 74 and a diene content of 4.5 mass %) and the resulting mixture was kneaded by means of rolls and formed into a sheet to be pelletized.

Then, the resulting pellets, 33 parts by mass of a polypropylene (NOVATECH BC6C available from Japan Polypropylene Corporation) as the thermoplastic resin based on 100 parts by mass of the EPDM contained in the pellets, and 3.38 parts by mass of an alkylphenol formaldehyde resin having methylol groups at opposite molecular terminals thereof (TACKIROL 201 available from Taoka Chemical Co., Ltd.) as the crosslinking agent based on 100 parts by mass of the pellets were fed into a feeder of a single/twin screw hybrid extruder, and the resulting mixture was kneaded in the extruder with heating, whereby the EPDM was dynamically crosslinked. Thus, a thermoplastic elastomer composition was prepared. Conditions for the dynamic crosslinking by the kneading were a temperature of 200° C. and a screw rotation speed of 50 rpm. It is noted that the alkylphenol formaldehyde resin was ground in a mortar before being fed into the extruder.

The proportion of the alkylphenol formaldehyde resin was 75.1 mass % based on the diene amount of the EPDM, and the proportion of p-toluenesulfonic acid monohydrate was 0.74 mass % based on the amount of the alkylphenol formaldehyde resin.

### Example 2

A thermoplastic elastomer composition was prepared in substantially the same manner as in Example 1, except that the amount of p-toluenesulfonic acid monohydrate was 0.1 part by mass.

The proportion of the alkylphenol formaldehyde resin was 75.1 mass % based on the diene amount of the EPDM, and the proportion of p-toluenesulfonic acid monohydrate was 2.96 mass % based on the amount of the alkylphenol formaldehyde resin.

### Example 3

A thermoplastic elastomer composition was prepared in substantially the same manner as in Example 1, except that the amount of the alkylphenol formaldehyde resin was 8.5 parts by mass and the amount of p-toluenesulfonic acid monohydrate was 0.07 parts by mass.

The proportion of the alkylphenol formaldehyde resin was 188.9 mass % based on the diene amount of the EPDM, and the proportion of p-toluenesulfonic acid monohydrate was 0.82 mass % based on the amount of the alkylphenol formaldehyde resin.

### Example 4

A thermoplastic elastomer composition was prepared in substantially the same manner as in Example 1, except that the amount of the alkylphenol formaldehyde resin was 8.5 parts by mass and the amount of p-toluenesulfonic acid monohydrate was 0.25 parts by mass.

The proportion of the alkylphenol formaldehyde resin was 188.9 mass % based on the diene amount of the EPDM, and the proportion of p-toluenesulfonic acid monohydrate was 2.94 mass % based on the amount of the alkylphenol formaldehyde resin.

### Example 5

A thermoplastic elastomer composition was prepared in substantially the same manner as in Example 1, except that the amount of the alkylphenol formaldehyde resin was 13.5 parts by mass and the amount of p-toluenesulfonic acid monohydrate was 0.1 part by mass.

The proportion of the alkylphenol formaldehyde resin was 300 mass % based on the diene amount of the EPDM, and the proportion of p-toluenesulfonic acid monohydrate was 0.74 mass % based on the amount of the alkylphenol formaldehyde resin.

### Example 6

A thermoplastic elastomer composition was prepared in substantially the same manner as in Example 1, except that the amount of the alkylphenol formaldehyde resin was 13.5 parts by mass and the amount of p-toluenesulfonic acid monohydrate was 0.4 parts by mass.

The proportion of the alkylphenol formaldehyde resin was 300 mass % based on the diene amount of the EPDM, and the proportion of p-toluenesulfonic acid monohydrate was 2.96 mass % based on the amount of the alkylphenol formaldehyde resin.

### Comparative Example 1

A thermoplastic elastomer composition was prepared in substantially the same manner as in Example 1, except that 3.38 parts by mass of a brominated alkylphenol formaldehyde resin (TACKIROL 250-III available from Taoka Chemical Co., Ltd.) ground in a mortar was blended instead of the alkylphenol formaldehyde resin as the crosslinking agent, and 1.0 part by mass of zinc white (ZINC OXIDE TYPE-2) was blended instead of p-toluenesulfonic acid monohydrate.

### Comparative Example 2

A thermoplastic elastomer composition was prepared in substantially the same manner as in Comparative Example 1, except that the amount of the brominated alkylphenol formaldehyde resin was 8.5 parts by mass.

### Comparative Example 3

A thermoplastic elastomer composition was prepared in substantially the same manner as in Comparative Example 1, except that the amount of the brominated alkylphenol formaldehyde resin was 13.5 parts by mass.

### Comparative Example 4

A thermoplastic elastomer composition was prepared in substantially the same manner as in Example 1, except that the amount of the alkylphenol formaldehyde resin was 3.38 parts by mass and the amount of p-toluenesulfonic acid monohydrate was 0.004 parts by mass.

The proportion of the alkylphenol formaldehyde resin was 75.1 mass % based on the diene amount of the EPDM, and the proportion of p-toluenesulfonic acid monohydrate was 0.12 mass % based on the amount of the alkylphenol formaldehyde resin.

### Comparative Example 5

A thermoplastic elastomer composition was prepared in substantially the same manner as in Example 1, except that the amount of the alkylphenol formaldehyde resin was 8.5 parts by mass and the amount of p-toluenesulfonic acid monohydrate was 0.01 part by mass.

The proportion of the alkylphenol formaldehyde resin was 188.9 mass % based on the diene amount of the EPDM, and the proportion of p-toluenesulfonic acid monohydrate was 0.12 mass % based on the amount of the alkylphenol formaldehyde resin.

### Comparative Example 6

A thermoplastic elastomer composition was prepared in substantially the same manner as in Example 1, except that the amount of the alkylphenol formaldehyde resin was 13.5 parts by mass and the amount of p-toluenesulfonic acid monohydrate was 0.016 parts by mass.

The proportion of the alkylphenol formaldehyde resin was 300 mass % based on the diene amount of the EPDM, and the proportion of p-toluenesulfonic acid monohydrate was 0.12 mass % based on the amount of the alkylphenol formaldehyde resin.

### Comparative Example 7

A thermoplastic elastomer composition was prepared in substantially the same manner as in Example 1, except that the amount of the alkylphenol formaldehyde resin was 3.38 parts by mass and the amount of p-toluenesulfonic acid monohydrate was 1.0 part by mass.

The proportion of the alkylphenol formaldehyde resin was 75.1 mass % based on the diene amount of the EPDM, and the proportion of p-toluenesulfonic acid monohydrate was 29.6 mass % based on the amount of the alkylphenol formaldehyde resin.

### Comparative Example 8

A thermoplastic elastomer composition was prepared in substantially the same manner as in Example 1, except that the amount of the alkylphenol formaldehyde resin was 8.5 parts by mass and the amount of p-toluenesulfonic acid monohydrate was 2.5 parts by mass.

The proportion of the alkylphenol formaldehyde resin was 188.9 mass % based on the diene amount of the EPDM, and the proportion of p-toluenesulfonic acid monohydrate was 29.4 mass % based on the amount of the alkylphenol formaldehyde resin.

### Comparative Example 9

A thermoplastic elastomer composition was prepared in substantially the same manner as in Example 1, except that the amount of the alkylphenol formaldehyde resin was 13.5 parts by mass and the amount of p-toluenesulfonic acid monohydrate was 4.0 parts by mass.

The proportion of the alkylphenol formaldehyde resin was 300 mass % based on the diene amount of the EPDM, and the proportion of p-toluenesulfonic acid monohydrate was 29.6 mass % based on the amount of the alkylphenol formaldehyde resin.

### Comparative Example 10

A thermoplastic elastomer composition was prepared in substantially the same manner as in Example 3, except that 0.07 parts by mass of benzoic acid (having a pH of not lower than 2.0) which was a weak Bronsted acid was blended instead of p-toluenesulfonic acid monohydrate.

### Comparative Example 11

A thermoplastic elastomer composition was prepared in substantially the same manner as in Comparative Example 10, except that the amount of benzoic acid was 0.25 parts by mass.

### Comparative Example 12

A thermoplastic elastomer composition was prepared in substantially the same manner as in Example 3, except that 0.07 parts by mass of ferrous sulfate heptahydrate which was a Lewis acid was blended instead of p-toluenesulfonic acid monohydrate.

### Comparative Example 13

A thermoplastic elastomer composition was prepared in substantially the same manner as in Comparative Example 12, except that the amount of ferrous sulfate heptahydrate was 0.25 parts by mass.

<Tensile Test>

A dumbbell-shaped No. 3 test strip specified in the Japanese Industrial Standards JIS K6251:2010 “Rubber, vulcanized or thermoplastic—Determination of tensile stress-strain properties” was prepared by forming a 2-mm thick sheet from each of the thermoplastic elastomer compositions prepared in Examples and Comparative Examples and stamping the sheet with the use of a predetermined die.

The tensile strength TS, the breaking elongation E_{b} and the 100% modulus (tensile stress S_{c} at a predetermined elongation) of the test strip were measured in conformity with the measurement methods specified in JIS K6251:2010. The measurement values for Examples and Comparative Examples were each converted into a relative value with measurement values for Comparative Example 2 being each defined as 100.

The results are shown in Tables 1 to 4.

In Tables 1 to 4, alphanumeric characters shown in the rows “Types” of “Crosslinking agent” and “Catalyst” indicate the following crosslinking agents and catalysts.

<Crosslinking Agent>

(1) The alkylphenol formaldehyde resin having methylol groups at opposite molecular terminals thereof (TACKIROL 201 available from Taoka Chemical Co., Ltd.)
(2) The brominated alkylphenol formaldehyde resin (TACKIROL 250-III available from Taoka Chemical Co., Ltd.)

### <Catalyst>

(a) p-Toluenesulfonic acid monohydrate (strong Bronsted acid)
(b) Zinc white (ZINC OXIDE TYPE-2)
(c) Benzoic acid (weak Bronsted acid)
(d) Ferrous sulfate heptahydrate (Lewis acid)

TABLE 1

| | | | | | |
|---|---|---|---|---|---|
| Example 1 | Example 2 | Example 3 | Example 4 | Example 5 | Example 6 |

EPDM

| | | | | | | |
|---|---|---|---|---|---|---|
| Parts by mass | 100 | 100 | 100 | 100 | 100 | 100 |

Crosslinking agent

| | | | | | | |
|---|---|---|---|---|---|---|
| Type | (1) | (1) | (1) | (1) | (1) | (1) |
| Parts by mass | 3.38 | 3.38 | 8.5 | 8.5 | 13.5 | 13.5 |
| Mass % (based on diene amount) | 75.1 | 75.1 | 188.9 | 188.9 | 300 | 300 |

Catalyst

| | | | | | | |
|---|---|---|---|---|---|---|
| Type | (a) | (a) | (a) | (a) | (a) | (a) |
| Parts by mass | 0.025 | 0.1 | 0.07 | 0.25 | 0.1 | 0.4 |
| Mass % (based on crosslinking agent amount) | 0.74 | 2.96 | 0.82 | 2.94 | 0.74 | 2.96 |

Tensile characteristic

| | | | | | | |
|---|---|---|---|---|---|---|
| Tensile strength TS | 160 | 160 | 175 | 165 | 100 | 125 |
| Breaking elongation E_{b} | 100 | 110 | 120 | 110 | 95 | 105 |
| 100% Modulus | 215 | 200 | 240 | 220 | 185 | 160 |

TABLE 2

| | Comparative | Comparative | Comparative | Comparative | Comparative |
|---|---|---|---|---|---|
| | Example 1 | Example 2 | Example 3 | Example 4 | Example 5 |
| EPDM | | | | | |
| Parts by mass | 100 | 100 | 100 | 100 | 100 |
| Crosslinking agent | | | | | |
| Type | (2) | (2) | (2) | (1) | (1) |
| Parts by mass | 3.38 | 8.5 | 13.5 | 3.38 | 8.5 |
| Mass % (based an diene amount) | — | — | — | 75.1 | 188.9 |
| Catalyst | | | | | |
| Type | (b) | (b) | (b) | (a) | (a) |
| Parts by mass | 1.0 | 1.0 | 1.0 | 0.004 | 0.01 |
| Mass % (based on | — | — | — | 0.12 | 0.12 |
| crosslinking agent amount) | | | | | |
| Tensile characteristic | | | | | |
| Tensile strength TS | 85 | 100 | 95 | 60 | 65 |
| Breaking elongation E_{b} | 75 | 100 | 95 | 60 | 65 |
| 100% Modulus | 120 | 100 | 90 | 80 | 85 |

TABLE 3

| | Comparative | Comparative | Comparative | Comparative |
|---|---|---|---|---|
| | Example 6 | Example 7 | Example 8 | Example 9 |
| EPDM | | | | |
| Parts by mass | 100 | 100 | 100 | 100 |
| Crosslinking agent | | | | |
| Type | (1) | (1) | (1) | (1) |
| Parts by mass | 13.5 | 3.38 | 8.5 | 13.5 |
| Mass % (based on diene amount) | 300 | 75.1 | 188.9 | 300 |
| Catalyst | | | | |
| Type | (a) | (a) | (a) | (a) |
| Parts by mass | 0.016 | 1.0 | 2.5 | 4.0 |
| Mass % (based on | 0.12 | 29.6 | 29.4 | 29.6 |
| crosslinking agent amount) | | | | |
| Tensile characteristic | | | | |
| Tensile strength TS | 65 | 80 | 90 | 75 |
| Breaking elongation E_{b} | 65 | 90 | 95 | 80 |
| 100% Modulus | 85 | 95 | 90 | 85 |

TABLE 4

| | Comparative | Comparative | Comparative | Comparative |
|---|---|---|---|---|
| | Example 10 | Example 11 | Example 12 | Example 13 |
| EPDM | | | | |
| Parts by mass | 100 | 100 | 100 | 100 |
| Crosslinking agent | | | | |
| Type | (1) | (1) | (1) | (1) |
| Parts by mass | 8.5 | 8.5 | 8.5 | 8.5 |
| Mass % (based on diene amount) | — | — | — | — |
| Catalyst | | | | |
| Type | (c) | (c) | (d) | (d) |
| Parts by mass | 0.07 | 0.25 | 0.07 | 0.25 |
| Mass % (based on | — | — | — | — |
| crosslinking agent amount) | | | | |
| Tensile characteristic | | | | |
| Tensile strength TS | 50 | 55 | 70 | 70 |
| Breaking elongation E_{b} | 60 | 60 | 65 | 70 |
| 100% Modulus | 70 | 65 | 70 | 70 |

The results for Examples 1 to 6 and Comparative Examples 1 to 3 shown in Tables 1 and 2 indicate that, where the alkylphenol formaldehyde resin having methylol groups at opposite molecular terminals thereof is used instead of the conventional brominated alkylphenol formaldehyde resin as the crosslinking agent and the strong Bronsted acid is used as the catalyst, the tensile characteristic of the thermoplastic elastomer composition can be improved.

The results for Comparative Examples 10 to 13 shown in Table 4 indicate that, where the weak Bronsted acid or the Lewis acid is used instead of the strong Bronsted acid, it is impossible to provide the desired effects.

The results for Examples 1 to 6 and Comparative Examples 4 to 9 shown in Tables 2 and 3 indicate that, where the alkylphenol formaldehyde resin and the strong Bronsted acid are used in combination, the proportion of the alkylphenol formaldehyde resin should be limited to the range of not less than 75 mass % and not greater than 300 mass % based on the diene amount of the EPDM and the proportion of the strong Bronsted acid should be limited to the range of not less than 0.7 mass % and not greater than 3 mass % based on the amount of the alkylphenol formaldehyde resin in order to provide the desired effects.

The results for Examples 1 to 6 shown in Table 1 indicate that the proportion of the strong Bronsted acid is preferably not less than 3 parts by mass and not greater than 9 parts by mass based on 100 parts by mass of the EPDM for further improvement of the desired effects.

This application corresponds to Japanese Patent Application No. 2012-266372 filed in the Japan Patent Office on Dec. 5, 2012, the disclosure of which is incorporated herein by reference in its entirety.

What is claimed is:

1. A thermoplastic elastomer composition comprising:
an ethylene propylene diene rubber comprising 5-ethylidene-2-norbornene as a diene component;
not less than 75 mass % and not greater than 300 mass % of an alkylphenol formaldehyde resin having methylol groups at opposite molecular terminals thereof as a crosslinking agent based on a diene amount of the ethylene propylene diene rubber;
not less than 0.7 mass % and not greater than 3 mass % of a strong Bronsted acid as a catalyst based on an amount of the alkylphenol formaldehyde resin; and
a thermoplastic resin.

2. The thermoplastic elastomer composition according to claim 1, wherein the alkylphenol formaldehyde resin is present in a proportion of not less than 3 parts by mass and not greater than 9 parts by mass based on 100 parts by mass of the ethylene propylene diene rubber.

3. The thermoplastic elastomer composition according to claim 1, wherein the strong Bronsted acid is p-toluenesulfonic acid monohydrate.

4. The thermoplastic elastomer composition according to claim 2, wherein the strong Bronsted acid is p-toluenesulfonic acid monohydrate.

5. The thermoplastic elastomer composition according to claim 1, wherein the thermoplastic resin is a polypropylene.

6. The thermoplastic elastomer composition according to claim 2, wherein the thermoplastic resin is a polypropylene.

7. The thermoplastic elastomer composition according to claim 3, wherein the thermoplastic resin is a polypropylene.

8. The thermoplastic elastomer composition according to claim 4, wherein the thermoplastic resin is a polypropylene.

9. The thermoplastic elastomer composition according to claim 1, wherein the thermoplastic resin is present in a proportion of not less than 10 parts by mass and not greater than 400 parts by mass based on 100 parts by mass of the ethylene propylene diene rubber.

10. The thermoplastic elastomer composition according to claim 2, wherein the thermoplastic resin is present in a proportion of not less than 10 parts by mass and not greater than 400 parts by mass based on 100 parts by mass of the ethylene propylene diene rubber.

11. The thermoplastic elastomer composition according to claim 3, wherein the thermoplastic resin is present in a proportion of not less than 10 parts by mass and not greater than 400 parts by mass based on 100 parts by mass of the ethylene propylene diene rubber.

12. The thermoplastic elastomer composition according to claim 4, wherein the thermoplastic resin is present in a proportion of not less than 10 parts by mass and not greater than 400 parts by mass based on 100 parts by mass of the ethylene propylene diene rubber.

13. The thermoplastic elastomer composition according to claim 5, wherein the thermoplastic resin is present in a proportion of not less than 10 parts by mass and not greater than 400 parts by mass based on 100 parts by mass of the ethylene propylene diene rubber.

14. The thermoplastic elastomer composition according to claim 6, wherein the thermoplastic resin is present in a proportion of not less than 10 parts by mass and not greater than 400 parts by mass based on 100 parts by mass of the ethylene propylene diene rubber.

15. The thermoplastic elastomer composition according to claim 7, wherein the thermoplastic resin is present in a proportion of not less than 10 parts by mass and not greater than 400 parts by mass based on 100 parts by mass of the ethylene propylene diene rubber.

16. The thermoplastic elastomer composition according to claim 8, wherein the thermoplastic resin is present in a proportion of not less than 10 parts by mass and not greater than 400 parts by mass based on 100 parts by mass of the ethylene propylene diene rubber.
